(19) United States
(12) Patent Application Publication
(10) Pub. No.: US 2022/0057244 A1
(43) Pub. Date: Feb. 24, 2022

(54) SENSOR DRIFT HANDLING IN VIRTUAL FLOW METERING

(71) Applicant: GENERAL ELECTRIC COMPANY, Schenctady, NY (US)

(72) Inventors: Carlos Alberto Cavichioloi Gonzaga, Rio De Janeiro (BR); Tong Zhao, Shanghai (CN); Yu Ru, Shanghai (CN)

(73) Assignee: Baker Hughes, a GE Company, LLC, Houston, TX (US)

(21) Appl. No.: 17/275,763

(22) PCT Filed: Sep. 30, 2016
(86) PCT No.: PCT/CN2016/101048

§ 371 Date: Mar. 12, 2021

(51) Int. Cl. G01F 1/74; G01F 25/00

(52) U.S. Cl. CPC G01F 1/74; G01F 25/0007

(57) ABSTRACT

The present discussion relates to the addressing sensor drift issues in virtual flow meter applications. By way of example, in certain implementations: 1) pressure, temperature, or other sensors are prioritized based on one or more evaluation criteria, 2) a determination is made as to whether there are sensor drifts for those sensors with high priority, and 3) sensor readings experiencing drift, such as above a specified or measureable threshold, are compensated. In this manner, virtual flow meter accuracy is maintained over time.

### BACKGROUND

The subject matter disclosed herein relates to the use of virtual flow metering in resource production contexts, such as oil and gas production.

In various contexts where a fluid medium, either liquid or gas, is flowed between various locations, the flow may be controlled at least in part using measured flow aspects. Conventionally, physical flow meters may be provided at various states in the flow to provided data on the flow of the fluid at a given time and at a given location. By way of example, in a hydrocarbon production context, flow maters may be positioned at one or more locations in the production path to provide data on the flow of the production fluid through various parts of the production system.

By way of example, two types of flow meter technologies are physical flow meters and virtual flow meters. In the context of physical multiphase flow meters, these flow meters typically estimate the flow rate of each phase in question by utilizing a combination of techniques, which may each in turn utilize various electronic sensing devices, such as microwave sensors, electrical impedance sensors, doppler ultrasound sensors, gamma ray sensors, and so forth.

There may be various drawbacks associated with the use of physical flow meters, including cost (since expensive sensors are typically employed), reliability (since complex sensors are typically more susceptible to failure), communication and power supply issues (e.g., high power consumption to keep sensors working demands specific umbilical pipes), and precision and accuracy (generally, physical flow meters present measurement errors due to the complexity of a multiphase flow).

Virtual flow meters may also utilize various sensor systems and algorithms for estimating flow rates. However, virtual flow meters typically make use of less complex types of sensors (e.g. temperature and pressure sensors) from whose measurements flow data is estimated. Both the physical and virtual flow metering approaches typically utilize complex data-fusion algorithms for estimating flow rates based on the measurements provided by the sensing units.

The maintenance of virtual flow meter accuracy over the life of a production site (e.g., an oil or gas field) is one challenge to the successful deployment of virtual flow meters at certain sites, such as subsea locations. The use of virtual flow meters may be subject to errors attributable primarily to two sources: models and sensor measurements. Model errors may be related either to mathematical modeling not adequately addressing the underlying physics or wrong (or varying) parameter assumptions (pipe roughness variation due to the incrustation of minerals, diameter variation due to the formation of wax, and so forth). Sensor measurements can be subjected to bias, drifts, precision degradation, or even total sensor failure.

For example, pressure and temperature sensors are subject to sensor drift issues, i.e., a continual drifting of the sensor output over time in the same direction. For example, the drift rate of a conventional subsea pressure transmitter may be approximately +/−0.1% full scale per year, which is roughly 100 kPa per year. Such drift, especially with respect to pressure sensors, may adversely affect the accuracy of a virtual flow meter implementation.

### BRIEF DESCRIPTION

In one embodiment, a virtual flow meter is provided for assessing fluid flows of a fluid-gathering network. In accordance with this approach, a processor-based controller is provided that is configured to: acquire measurements from a plurality of sensors over time, wherein one or more of the plurality of sensors is determined to be a priority sensor; for each priority sensor, acquire sensor readings over a time interval and derive a change metric for the respective priority sensor of the respective time interval; compare the respective change metrics of each priority sensor to a specified threshold to determine if each priority sensor exhibits sensor drift; for those priority sensors exhibiting sensor drift, determine a direction and a value of the corresponding sensor drift; for those priority sensors exhibiting sensor drift, compensate the respective sensor drift in measurements derived from the respective sensor using the corresponding direction and value; and execute one of more virtual flow metering algorithms using the compensated sensor measurements to estimate fluid flow rates within a production network.

In accordance with a further embodiment, a processor-based method is provided for addressing sensor drift in a fluid production network. In accordance with this method, measurements are acquired from a plurality of sensors over time. One or more of the plurality of sensors is determined to be a priority sensor. For each priority sensor, sensor readings are acquired over a time interval and a change metric is derived for the respective priority sensor over the respective time interval. The respective change metrics of each priority sensor is compared to a specified threshold to determine if each priority sensor exhibits sensor drift. For those priority sensors exhibiting sensor drift, a direction and a value of the corresponding sensor drift is determined. For those priority sensors exhibiting sensor drift, the respective sensor drift is compensated in measurements derived from the respective sensor using the corresponding direction and value. One of more virtual flow metering algorithms are executed using the compensated sensor measurements to estimate fluid flow rates within a production network.

In an additional embodiment, one or more computer-readable media comprising executable routines are provided. The routines, when executed by a processor cause acts to be performed comprising: acquiring measurements from a plurality of sensors over time, wherein one or more of the plurality of sensors is determined to be a priority sensor; for each priority sensor, acquiring sensor readings over a time interval and deriving a change metric for the respective priority sensor over the respective time interval; comparing the respective change metrics of each priority sensor to a specified threshold to determine if each priority sensor exhibits sensor drift; for those priority sensors exhibiting sensor drift, determining a direction and a value of the corresponding sensor drift; for those priority sensors exhibiting sensor drift, compensating the respective sensor drift in measurements derived from the respective sensor using the corresponding direction and value; and executing one of more virtual flow metering algorithms using the compensated sensor measurements to estimate fluid flow rates within a production network.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts a generalized view of a resource production system suitable for use with a virtual flow metering algorithm, in accordance with aspects of the present disclosure;

FIG. 2 depicts a process flow for prioritizing sensors, in accordance with aspects of the present disclosure;

FIG. 3 depicts a process flow for determining the presence of sensor drift, in accordance with aspects of the present disclosure; and

FIG. 4 depicts a process flow for compensating sensor drift, in accordance with aspects of the present disclosure.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As described herein, a virtual flow meter measures real-time estimates of the mass and volumetric flow rates of oil, gas, and water from one or more wells in a production network by combining distributed pressure and temperature measurements with hydraulic and thermodynamic models of the multiphase flow through the system. Measurements from pressure and temperature sensors are subject to drift over time due to the sensors being engineered from various materials that respond differently depending on the physical properties of the materials chosen when exposed to certain conditions. Sensor drift reduces the accuracy of virtual flow meter estimates if such drift is not addressed.

In accordance with the present approach, drift issues (including pressure sensor drift) is addressed in virtual flow meter applications. By way of example, in certain implementations: 1) pressure, temperature, or other sensors are prioritized based on one or more evaluation criteria, 2) a determination is made as to whether there are drifts for those sensors with high priority, and 3) sensor readings experiencing drift, such as above a specified or measureable threshold, are compensated. In this manner, virtual flow meter accuracy is maintained over time while correcting sensor drifts only when necessary.

One aspect of this approach is the sensitivity analysis employed to detect and classify (i.e., prioritize) the sensors among a potentially large network that, in case of drift, will yield performance loss in the estimation process. As discussed herein and noted above, the correction is thus focused on such prioritized sensors.

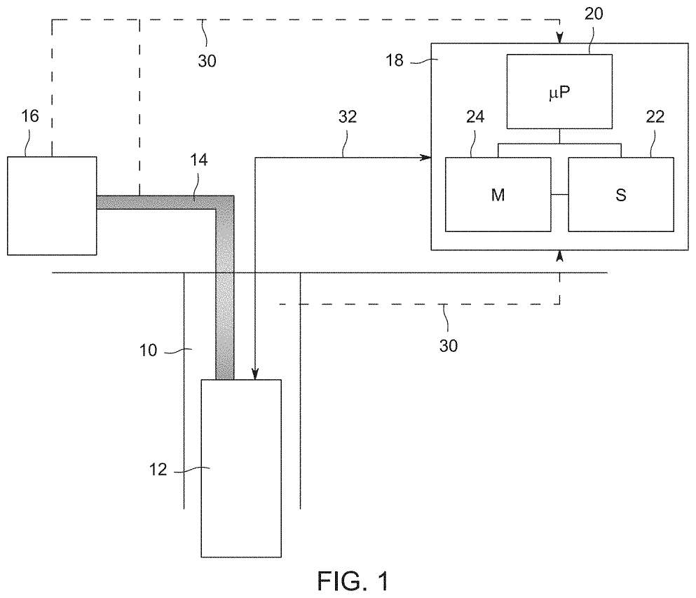

With the preceding in mind, a high-level, simplified overview of aspects of a production site and control system employing a virtual flow meter are shown in FIG. 1. In this example, a hydrocarbon production site is depicted. Such a site may be subsea or on-shore. In this example, the site includes a downhole environment (e.g., a wellbore 10) in which a downhole tool 12 is positioned. The downhole tool 12 may include one or more pumps, such as electric submersible pumps (ESPs), that facilitate the movement of a production fluid 14 from the downhole environment to a downstream facility 16, such as storage tanks, separators or separation tanks, and so forth.

In the depicted example, the flow of the production fluid 14 may be controlled at least in part by the operation of the downhole tool 12 or, in alternative approaches by changing the opening of choke valves located in production manifolds, Christmas trees, a topside separator, or other flow diversion or restriction locations in the production flow path. With reference to the depicted example, the operation of the downhole tool 12 is, in this example, controlled at least in part by the operation of a controller 18 configured to implement a virtual flow meter as discussed herein. Though the downhole tool 12 in this example is depicted as being in communication with, and operated based on, the controller 18, it should be appreciated that other pumps or flow control devices may be operated based on the controller 18 in addition to or instead of the downhole tool 12. For example, the controller 18 (or other similarly configured controllers 18 at the site) may control other devices or components that cause the flow of the production fluid 14 between locations at the monitored site.

In the depicted embodiment, the controller 18 is a processor-based controller, having at least one microprocessor 20 to execute an algorithm corresponding to a virtual flow meter. For example, the microprocessor 20 may execute stored routines corresponding to the virtual flow meter algorithms (including routines for sensor drift correction as discussed herein) stored in a storage 22 and/or memory 24 of the controller 18. The processor 20 may also access sensor data 30 acquired from one or more sensor (e.g., pressure and/or temperature sensors) located at locations (as shown by dashed lines 30) in the fluid flow path. In the same manner, in certain embodiments sensor and/or operational data may be provided to the controller 18 by a tool 12 responsible for the flow of the production fluid 14. Though the controller 18 is depicted in FIG. 1 as a stand-alone or specially programmed device, it should be understood that the functionality of the controller 18 (e.g., executing routines for implementing a virtual flow meter algorithm employing sensor drift correction as discussed herein) may be one set of routines executed on a computer or other processor-based system that, in addition, executes other routines and performs other functions. Further, though a processor-based implementation is shown in FIG. 1, in alternative implementations the controller 18 may be implemented as one or more application-specific integrated circuits specifically programmed to perform the routines associated with the virtual flow meter described herein when provided with the proper inputs.

In the depicted example, the controller 18 receives sensor input data, such as from pressure, temperature, and/or mass flow sensors in the fluid flow path, and acts as virtual flow meter, generating an estimate of the flow of the production fluid 14 at one or more locations in the monitored site. The flow estimates in the depicted example may be used to generate a control signal 32 used to control the operation of one or more flow controlling devices, such as pumps, valves, and so forth. In the depicted example, the control signal 32 is used to control operation of the downhole tool 12, such as an electrical submersible pump or other pumping device. In this manner, based on the flow estimated by the virtual flow meter implemented on controller 18, the operation of one or more flow controlling devices may be controlled so as to stay within desired production parameters.

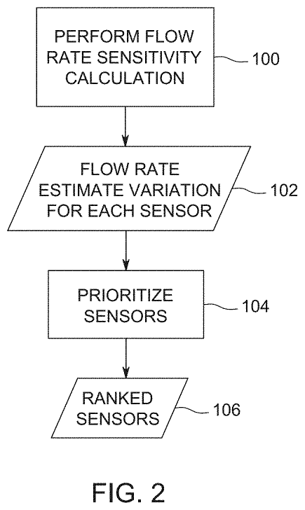

As discussed herein, the present approach allows for the correction of sensor data to the virtual flow meter algorithm to address sensor drift over time. In accordance with this approach, various steps (shown in process flow form in FIGS. 2-4) may be employed, certain of which are discussed herein. By way of example, in one implementation a step 100 is performed of performing a flow rate sensitivity calculation.

In one embodiment, the flow rate sensitivity calculation, performed at step 100 of FIG. 2, calculates the relative flow rate estimate variation when a certain pressure change occurs for each pressure sensor (block 102) (e.g., 10 kPa increase due to sensor drift). The calculation can be done using approaches leveraging finite difference or estimation error minimizing Kalman gain as used in the virtual flow meter. For the pressure drift correction, as previously noted, in one study an analysis was performed to identify the sensors with high or disproportionate impact on the estimation process, instead of correcting any sensor subject to drift. As will be appreciated, such an approach is related to the sensitivity of the estimator, which may result in a time consuming task.

With the preceding in mind, one aspect of this approach is to analyze the impact of a sensor drift on the flow rate estimation by taking into account the variation on the estimated mass flow rate under a single iteration. As discussed herein, such an approach may be characterized as a one-step operator and it is directly related to the Kalman filter gain previously defined. Assuming a network of twenty five pressure sensors, the correction step equation of the estimated mass flow rates is:

\dot{\hat{m}}_{k+1|k+1}=\dot{\hat{m}}_{k+1|k}+K_{k+1|k}(Δp_{k+1|k+1}−C_{k+1|k}\dot{\hat{m}}_{k+1|k}),k∈ [symbol] (1)

where \dot{\hat{m}}_{k+1|k}∈ [symbol] ⁵ is the current estimated gas mass flow rates vector, K_{k+1|k} ∈ [symbol] ^{5×27} is the Kalman gain, Cₖ ∈ [symbol] ^{27×5} is the linearized output map (forward model) and Δp_{k+1|k+1}∈ [symbol] ²⁴ is the updated pressure drops at time instant k+1. At steady-state operation of the filter, the gain was the one determined to minimize the squared estimate error Δp_{k+1|k+1}−C_{k+1|l}\dot{\hat{m}}_{k+1|k}.

The aim of this approach is to provide a solution to the following problem: assuming a normal operation, determine the impact a given drift on node pressure sensors has on the updated gas mass flow rate. It is worth mentioning that the assumption of normal operation may be made in order to have the following condition held for the measurement noise covariance matrix R_{k+1|k+1}=R_{k+1|k}. This is a condition for the pre-calculated Kalman gain K to remain valid. At this point, the absolute values may be considered by taking into account that the pressure drop along a given element is equivalently defined as follows:

$$Δ p = [ \begin{matrix}Δ {p}^{12} \\ Δ {p}^{23} \\ Δ {p}^{34} \\ Δ {p}^{45} \\ Δ {p}^{56} \\ Δ {p}^{67} \\ Δ {p}^{38} \\ ⋮ \\ Δ {p}^{24 \; 25}\end{matrix} ] = [ \begin{matrix}- 1 & 1 & 0 & 0 & 0 & 0 & 0 & 0 & … & 0 & 0 \\ 0 & - 1 & 1 & 0 & 0 & 0 & 0 & 0 & … & 0 & 0 \\ 0 & 0 & - 1 & 1 & 0 & 0 & 0 & 0 & … & 0 & 0 \\ 0 & 0 & 0 & - 1 & 1 & 0 & 0 & 0 & … & 0 & 0 \\ 0 & 0 & 0 & 0 & - 1 & 0 & 0 & 0 & … & 0 & 0 \\ 0 & 0 & 0 & 0 & 0 & - 1 & 1 & 0 & … & 0 & 0 \\ 0 & 0 & - 1 & 0 & 0 & 0 & 0 & 1 & 0 & 0 & 0 \\ ⋮ & ⋮ & ⋮ & ⋮ & ⋮ & ⋮ & ⋮ & ⋮ & ⋱ & 0 & 0 \\ 0 & 0 & 0 & 0 & 0 & 0 & ⋯ & 0 & … & - 1 & 1\end{matrix} ] [ \begin{matrix}{p}^{1} \\ {p}^{2} \\ {p}^{3} \\ {p}^{4} \\ {p}^{5} \\ {p}^{6} \\ {p}^{7} \\ {p}^{8} \\ ⋮ \\ {p}^{24} \\ {p}^{25}\end{matrix} ] \qquad ( 2 )$$

Regarding the linear transformation [symbol] ∈ [symbol] ^{24×25}, which allows obtaining the pressure drops to be passed as inputs for the flow soft sensor, the j-th pressure sensor subjected to drift p̅^{j}=p^{j}+δp^{j} affects two different flow soft sensor inputs. Hence, the impact on the one-step operator is given as follows:

\dot{\hat{m}}_{k+1|k+1}=\dot{\hat{m}}_{k+1|k}+ [symbol] _{k+1|k}δp_{k+1|k+1}, (3)

with [symbol] _{k+1|k}=K_{k+1|k} [symbol] _{. For simplicity, a case related to the sensors involved in a well path with seven pressure sensors may be considered:}

$${\hat{\dot{m}}}_{k + 1 \vert k + 1} - {\hat{\dot{m}}}_{k + 1 \vert k} = {[ \begin{matrix}- {k}^{( 1 )} \\ {k}^{( 1 )} - {k}^{( 2 )} \\ {k}^{( 2 )} - {k}^{( 3 )} - {k}^{( 7 )} \\ {k}^{( 3 )} - {k}^{( 4 )} \\ {k}^{( 4 )} - {k}^{( 5 )} \\ {k}^{( 5 )} - {k}^{( 6 )} \\ {k}^{( 6 )}\end{matrix} ]}^{′} δ {p}_{k + 1 \vert k + 1} , \qquad ( 4 )$$

where k^{(j)} stands for the j-th component of the gain vector K∈ [symbol] ^{1×25}. At the following step, the sensitivity results 102 may be employed. The results 102 help prioritize (block 104) the pressure sensors for sensor drift handling. The results 102 may also provide the lower limit of sensor drift to consider, i.e., may be used to establish the threshold sensor drift to be addressed. As will be appreciated, though the described example relates to pressure sensors and estimating flow rate variation for prescribed pressure changes, other types of sensors and sensor measurements may be handled similarly. For example, in a temperature sensor implementation, relative flow rate estimate variation when a certain temperature change occurs for each temperature sensor may instead be calculated.

Turning back to FIG. 2, based on the results 102 of the flow rate sensitivity calculation (step 100), the sensors in question may be prioritized (step 104) to generate a ranked list 106 of sensors based on the relative impact of each sensor on flow rate estimation by the virtual flow meter. Thus, from the ranked sensors 106 it may be determined which sensors have large impact on flow rate estimation.

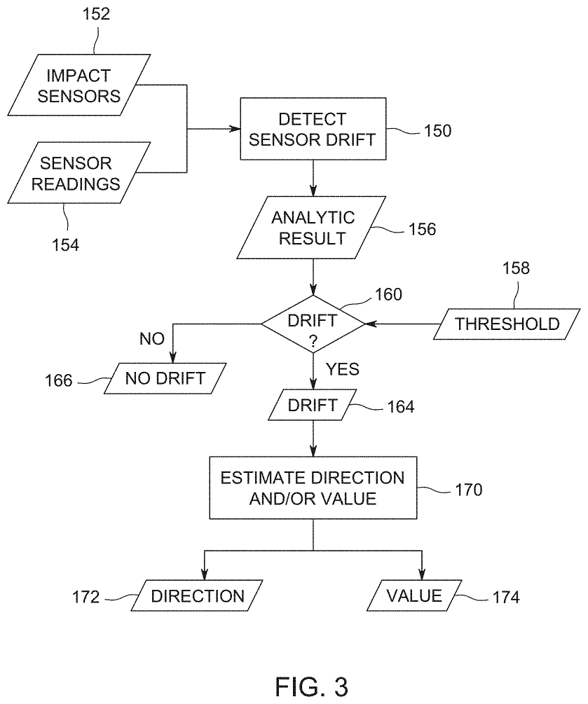

Turning to FIG. 3, at step 150, sensor drift detection is performed for those sensors 152 determined to have a large impact on flow estimation as determined from the prioritized or ranked sensor list 106 previously determined. The sensors 152 determined to have a large impact may be derived in various ways, including use of an absolute or relative threshold with respect to impact on the estimated flow, determining the x number of top ranked sensors in the prioritized list 106, determining the top x % impactful sensors in the prioritized list 106, determining sensors having an impact of greater than x standard deviations above the mean impact, and so forth.

In one implementation, for each sensor 152 having a large impact on flow rate estimation a finite difference or regression (e.g., linear regression) is calculated using sensor readings 154 from the respective sensor in a certain time window (e.g., one month or one year). If the absolute value of the estimated slope (in the case of a linear regression) (result 156) or other change metric is above a prescribed threshold 158, sensor drift 164 is deemed to be detected (with no drift 166 detected otherwise). If drift 164 is detected, the sensor drift direction 172 (i.e., increasing or decreasing) and the drift value 174 can also be estimated (step 170).

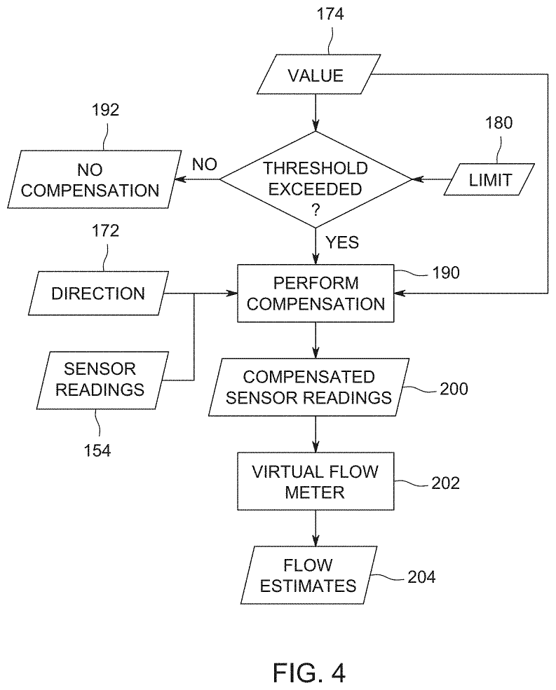

Turning to FIG. 4, if the drift value 174 is larger than the identified limit 180 (e.g., lower limit) identified in the flow rate sensitivity calculation step 100, sensor drift compensation 190 is appropriate. Otherwise, no compensation 192 is deemed necessary. In particular, since the drift direction 172 and the drift value 174 have been identified by the present processes, sensor drift can be compensated automatically for a given sensor reading 154 to generate compensated sensor readings 200. Alternatively, a user may also be allowed to perform the compensation manually. The compensated sensor readings 200 may then be used in the virtual flow meter 202 instance to derive estimates of fluid flow 204 that may be used in the monitoring and/or control of flow at a production site.

Technical effects of the invention include providing a systematic framework for handling sensor drift. The present approach may be applicable in other settings that rely on field sensors. One advantage of the present approach is that it helps maintain the virtual flow meter accuracy over time.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A virtual flow meter, comprising:
a processor-based controller configured to:
acquire measurements from a plurality of sensors over time, wherein one or more of the plurality of sensors is determined to be a priority sensor;
for each priority sensor, acquire sensor readings over a time interval and derive a change metric for the respective priority sensor over the respective time interval;
compare the respective change metrics of each priority sensor to a specified threshold to determine if each priority sensor exhibits sensor drift;
for those priority sensors exhibiting sensor drift, determine a direction and a value of the corresponding sensor drift;
for those priority sensors exhibiting sensor drift, compensate the respective sensor drift in measurements derived from the respective sensor using the corresponding direction and value; and
execute one of more virtual flow metering algorithms using the compensated sensor measurements to estimate fluid flow rates within a production network.

2. The virtual flow meter of claim 1, wherein the controller comprises a processor based-controller.

3. The virtual flow meter of claim 1, wherein the controller comprises an application specific integrated circuit.

4. The virtual flow meter of claim 1, wherein the controller is further configured to:
perform a flow rate sensitivity calculation to determine which sensors of the plurality of sensors are priority sensors.

5. The virtual flow meter of claim 4, wherein the flow sensitivity calculation estimates the variation in relative flow rate estimate in response to temperature or pressure changes for each sensor.

6. The virtual flow meter of claim 1, wherein the plurality of sensors comprise temperature sensors or pressure sensors.

7. The virtual flow meter of claim 1, wherein the change metric for the respective priority sensors comprises an absolute value of an estimated slope.

8. The virtual flow meter of claim 7, wherein the estimated slope is derived using finite difference or regression performed on the respective sensor reading over the time interval for the respective priority sensor.

9. A processor-based method for addressing sensor drift in a fluid production network, comprising:
acquiring measurements from a plurality of sensors over time, wherein one or more of the plurality of sensors is determined to be a priority sensor;
for each priority sensor, acquiring sensor readings over a time interval and deriving a change metric for the respective priority sensor over the respective time interval;
comparing the respective change metrics of each priority sensor to a specified threshold to determine if each priority sensor exhibits sensor drift;
for those priority sensors exhibiting sensor drift, determining a direction and a value of the corresponding sensor drift;
for those priority sensors exhibiting sensor drift, compensating the respective sensor drift in measurements derived from the respective sensor using the corresponding direction and value; and
executing one of more virtual flow metering algorithms using the compensated sensor measurements to estimate fluid flow rates within a production network.

10. The method of claim 9, further comprising the act of:
performing a flow rate sensitivity calculation to determine which sensors of the plurality of sensors are priority sensors.

11. The method of claim 10, wherein the flow sensitivity calculation estimates the variation in relative flow rate estimate in response to temperature or pressure changes for each sensor.

12. The method of claim 9, wherein the plurality of sensors comprise temperature sensors or pressure sensors.

13. The method of claim 9, wherein the change metric for the respective priority sensors comprises an absolute value of an estimated slope.

14. The method of claim 13, wherein the estimated slope is derived using finite difference or regression performed on the respective sensor reading over the time interval for the respective priority sensor.

15. One or more computer-readable media comprising executable routines, which when executed by a processor cause acts to be performed comprising:
acquiring measurements from a plurality of sensors over time, wherein one or more of the plurality of sensors is determined to be a priority sensor;
for each priority sensor, acquiring sensor readings over a time interval and deriving a change metric for the respective priority sensor over the respective time interval;
comparing the respective change metrics of each priority sensor to a specified threshold to determine if each priority sensor exhibits sensor drift;
for those priority sensors exhibiting sensor drift, determining a direction and a value of the corresponding sensor drift;
for those priority sensors exhibiting sensor drift, compensating the respective sensor drift in measurements derived from the respective sensor using the corresponding direction and value; and
executing one of more virtual flow metering algorithms using the compensated sensor measurements to estimate fluid flow rates within a production network.

16. The one or more computer-readable media of claim 15, wherein the routines, when executed by the processor causes the act to be performed of:
performing a flow rate sensitivity calculation to determine which sensors of the plurality of sensors are priority sensors

17. The one or more computer-readable media of claim 16, wherein the flow sensitivity calculation estimates the variation in relative flow rate estimate in response to temperature or pressure changes for each sensor.

18. The one or more computer-readable media of claim 15, wherein the plurality of sensors comprise temperature sensors or pressure sensors.

19. The one or more computer-readable media of claim 15, wherein the change metric for the respective priority sensors comprises an absolute value of an estimated slope.

20. The one or more computer-readable media of claim 19, wherein the estimated slope is derived using finite difference or regression performed on the respective sensor reading over the time interval for the respective priority sensor.
